(19) United States
(12) Patent Application Publication
(10) Pub. No.: US 2004/0080615 A1
(43) Pub. Date: Apr. 29, 2004

(54) Digital video security system

(75) Inventors: Larry Klein, Hashmonaim (IL); Joel Kligman, Toronto (CA)

Correspondence Address: Mark B. Eisen, Dimock Stratton Clarizio LLP, Suite 3202, Box 102, 20 Queen Street West, Toronto, M5H 3R3, CA

(73) Assignee: STRATEGIC VISTA INTENATIONAL INC.

(21) Appl. No.: 10/644,818

(22) Filed: Aug. 21, 2003

(30) Foreign Application Priority Data
Aug. 21, 2002 (CA) 2.399.269

(51) Int. Cl. H04N 7/18; H04N 9/47

(52) U.S. Cl. 348/143; 348/155

(57) ABSTRACT

A digital video security system comprises a video module and an event scheduling module for generating signals in response to at least one predefined event, such that the video module renders the video images in response to a signal generated by the event scheduling module. Predefined events include triggering events, such as motion detection, or a scheduled events, such as a preset date and time. Video images are recorded in a time-indexed file format, from which segments of footage may be extracted by reference to a database of time indices relating to the predefined events. Video images taken by the security system may be delivered in near real-time or at a later time using streaming technology. The security system is operable by either a host computer provided with a video camera or a remote computer, which are in communication over a network such as the Internet.

### FIELD OF THE INVENTION

The present invention generally relates to security systems, and specifically to remotely operable video surveillance systems.

### BACKGROUND OF THE INVENTION

Many security or surveillance systems employed in homes and businesses incorporate motion detection and video cameras for surveying a protected area.

Motion detection is typically accomplished through a passive system, such as an infrared detectors which detects changes in temperature in the monitored area, or on an active system such as ultrasonic or microwave sensors which detect moving objects in their field of detection. When motion is detected, a signal is delivered to a monitoring system, which may sound an alarm or report the incident to a security guard station or central service. Such motion detection systems typically require professional installation and may further require adjustment to avoid false reports from natural occurrences such as sunsets or other gradual variations in light quality or intensity.

Video cameras are used to provide real time or recorded surveillance of a protected area. The feed from the video cameras is usually directed to a monitoring station, such as a security guard station, or a central service, that provides monitoring services to a number of protected areas. If the feed is not monitored in real time, it may be recorded to video tape for future reference. However, a live video feed requires constant monitoring in order to detect security breaches; and when footage is recorded for later viewing, it is not easily correlated with a given event in time. For example, a convenience store security camera may record footage of the store entrance for a period of twelve hours; if a break-in is detected at an undetermined time during that twelve hours, the entire footage may have to be reviewed before the relevant break-in footage is located. Even if the time of the break-in is known, the user must fast-forward through the footage to locate the approximate segment corresponding to the time of the break-in.

Security systems may further be tied in with certain automated events; for example, when motion is detected, the system may sound an alarm and turn on the lights in the protected area. Configuring a security system to perform such automated events requires that the installer of the system attend on the protected premises to make adjustments to the system on-site; if alterations are to be made to the automated processes carried out by the security system, a further visit by an installer is required to effect those changes.

Accordingly, it is desirable to provide a security system that overcomes these disadvantages.

### SUMMARY OF THE INVENTION

The present invention provides a digital video security system that is operable in a local surveillance area, and over a computer network in a remote surveillance area. The digital video security system provides means for streaming video to a local computer and to a remote computer, either from video footage taken in real time or from a prerecorded file, and further provides means for rapidly identifying footage corresponding to a predetermined event, such as a motion detection, preset time, or other event.

One aspect of the invention provides a video module for rendering video images captured by a video camera and an event scheduling module for generating signals in response to at least one predefined event, where the video module renders the video images in response to a signal generated by the event scheduling module. The predefined event may include a triggering event, such as a motion detection, or a scheduled event, such as a preset date and time. Preferably, the video module can record the video images in a file format comprising time-indexed footage, from which segments of footage may be extracted by reference to a database of time indices relating to predefined events. Most preferably, the video images are delivered to the user in near real-time using a communications module, or at a later time using streaming technology.

Another aspect of the invention provides a method of motion detection through a differencing algorithm that compares a frame of captured video against a previous frame of captured video, or against a historical representation of previously captured video, to determine whether a change in video data outside the scope of preset tolerance levels has occurred.

The present invention further provides a system for managing a digital video file comprising time-indexed footage recorded by a video camera, having a database containing at least one external time index associated with a predefined event, means for presenting a list of the predefined events to a user, means for the user to select one of the list of predefined events, and means for replaying a portion of the video file that contains time-indexed footage corresponding to the external time index associated with the predefined event selected by the user from the list of predefined events. In a further aspect of the invention, the video file is replayed at a location remote from the video camera, and the means for the user to select one of the list of predefined events is at a location remote from the video camera. Yet another aspect of the invention is means for extracting a still image from the video footage corresponding to the external time index associated with the predefined event.

### BRIEF DESCRIPTION OF THE DRAWINGS

In drawings which illustrate by way of example only a preferred embodiment of the invention,

FIG. 1 is a schematic representation of a video surveillance system.

FIG. 2 is a schematic representation of a video interpretation module.

FIG. 3 is a flowchart representation of the image analyzer in the video interpretation module.

FIG. 4 is a schematic representation of an event generation module.

### DETAILED DESCRIPTION OF THE INVENTION

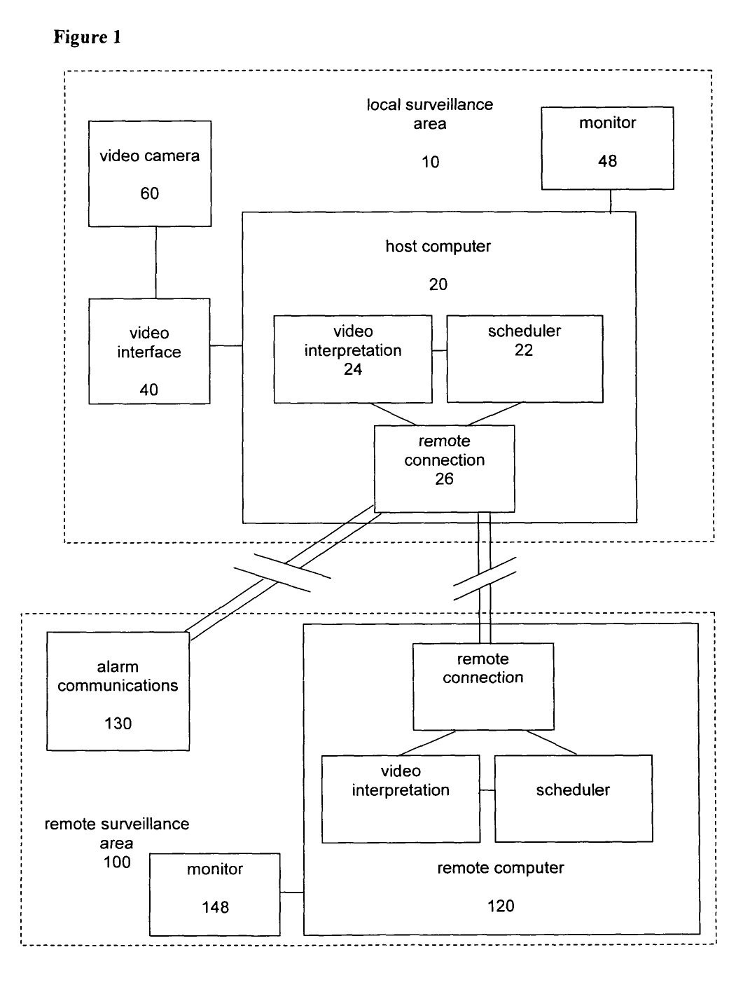

Referring to FIG. 1, the video surveillance system of the present invention comprises a local video surveillance connection and an optional remote video surveillance connection. The local video surveillance connection is located in the local surveillance area 10, which includes the specific area intended to be kept under surveillance.

A video camera 60 is mounted in a position in the local surveillance area 10 in the desired viewing location. The video camera 60 communicates via wire or wireless means with a video interface 40, which in turn is connected to a host computer 20. Preferably, the video camera 60 and the host computer 20 are powered by separate power supplies.

The host computer 20 includes software to control the recording, interpretation and reaction of the security system to the video input. The control software comprises three main components: a video interpretation module 24, a task scheduler and event generation module 22, and a remote communication module 26. While the components may be separate software objects, they interact with one another to permit full control over the surveillance system.

The remote communication module 26 provides means for transmitting information between the host computer 20 and at least one remote computer 120 over a network or direct connection, such as the Internet, a local area network, or a modem. The protocol used for transmitting information between the computers 20, 120 is any suitable protocol known in the field of computer network communications. The remote communication module 26 is activated by the security system whenever communication with a remote computer 120 is required; for example, where the security system must respond to commands issued from the remote computer 120 to issue commands locally to the video interpretation module 24 or the event generation module 22. The remote communication module 26 can also respond to locally issued commands from the video interpretation module 24 or the event generation module 22, and take action by issuing external alarm events to a user's choice of remote alarm communications means 130. Typical alarm communications means include telephone, SMS, pager, electronic mail or video electronic mail.

The remote communication module 21 further permits a remote connection from a remote computer 120 to the host computer 20 such that the user of the remote computer 120 has full functional access to the software, including viewing the video camera output as a video stream; the ability to edit and add alarm events; and the ability to review and change task scheduler entries.

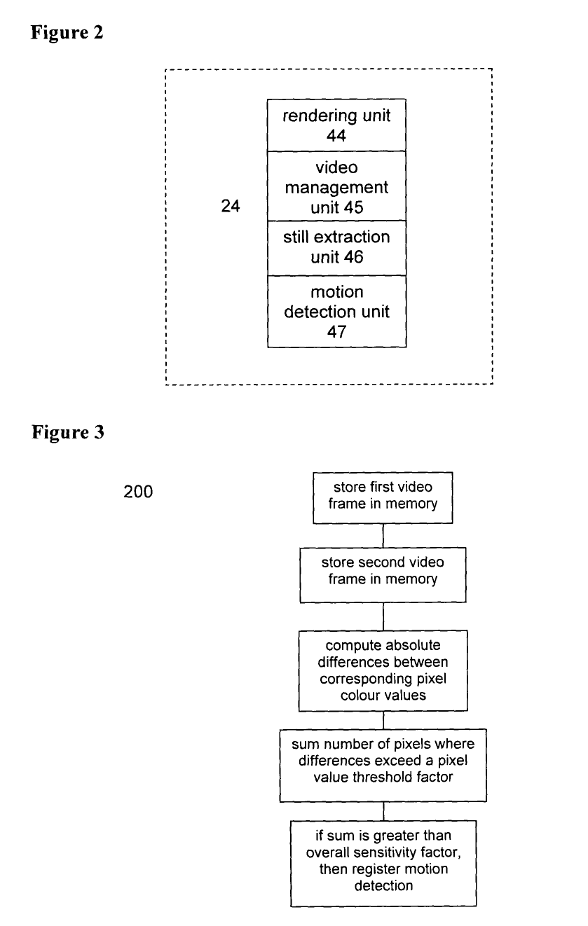

Turning to FIG. 2, the video interpretation module 24 comprises a rendering unit 44, a video management unit 45, a still extraction unit 46, and a motion detection unit 47. The rendering unit 44 receives a feed from the video camera 60 via the video interface 40, and renders the feed to a monitor 48 associated with the host computer 20. The rendering unit 44 delivers the feed to the monitor 48 in real time, thus allowing a user at the host computer 20 to maintain live surveillance of the local surveillance area 10. If a user is stationed at a remote computer 120, then the rendering unit 44 delivers the video feed to the monitor 148 associated with the remote computer 120 by means of the remote communication module 26. Such a video feed is delivered to the user at the remote computer 120 in near real time. Preferably, the video feed is delivered using a streaming file format, such Microsoft® Windows Media format. Most preferably, a microphone (not shown) is also set up in the local surveillance area 10 along with the video camera 60, such that the video feed rendered by the rendering unit 44 comprises sound. In another preferred embodiment, more than one camera 60 is connected to the host computer 20 and the feeds are received by the host computer 20 and rendered by the rendering unit 44 simultaneously, such as in a quad-screen format.

The security system software preferably includes access control means in the remote connection module 26 in order to maintain the security and integrity of the system. The access control requires the entry of a username and password in order to gain access to the features of the security surveillance system. Most preferably, a further encryption or scrambling algorithm is applied by the video module 24 to each frame of the video feed, to ensure that the video data transmitted from the host computer 20 to a remote computer 120 will be secure and unreadable by third parties. Such an algorithm may be implemented using an industry standard encryption algorithm, such as one of those available in the Microsoft® Windows Media® Rights Manager Software Development Kit (SDK). The remote computer 120 would therefore be provided with a decryption or descrambling key in order to descramble the video feed streamed from the host computer 20.

The video management unit 45 provides a management system for recording the video feed received by the camera 60 to a local storage medium associated with the host computer 20, or alternatively with a storage medium associated with the remote computer 120 by means of the remote communication module 26.

The video management unit 45 includes a database for recording associated event information with each video file stored by the video management unit 45. The event information includes information pertaining to the triggering event or scheduled task, described below, that caused a video file to be stored; the start and stop times of the video file; and any further triggering events or scheduled tasks that occurred between the start and stop signs. This database means enables the user to manage the surveillance video information and locate important events within a video file. For example, the video management unit 45 may record a 2 hour-long video file as a result of a scheduled task to record video during that time; during the two hours, a triggering event, such as a motion detection, described below, may occur which may normally trigger the video management unit 45 to record the video feed in any case. The database in the management unit 45 would contain external time references to both the commencement and ending of the 2-hour-long period, as well as an external time reference to the motion detection. The video management unit 45 may then use the external time reference in the database to locate the specific point in the stored video when the motion detection occurred, and then present that particular video clip to the user.

The still extraction unit 46 provides means for extracting and printing a still shot from a video file.

The motion detection unit 47 comprises an image analyzer that detects motion by comparing the current video frame with the preceding video frame or a video frame history. Referring to the flowchart 200 shown in FIG. 3, the first video image frame in the video stream received by the host computer 20 is saved into an array in memory. The next video image frame is also saved into an array in memory. Regions of interest, smaller sub-arrays within each image array, are defined to speed calculation and focus analysis on specific areas in the image.

The value of each pixel from the first video image within a region of interest is compared with the value of the corresponding pixel in the next video image. The pixel values, preferably their greyscale or colour channel values (for example, grayscale and red/green/blue values ranging between 0 and 255), are compared. By summing the absolute value of the difference between the pixel values within each region of interest, a value representing the change in the image content is obtained. The greater the change in the image content, the larger the magnitude of the summed pixel differences.

Since digital cameras are prone to statistical variations in output, several threshold factors are applied to ensure that a change in pixel value is due to a change in content as opposed to a random fluctuation in pixel value, for example due to ambient light fluctuations. The first threshold factor is an overall sensitivity factor applied to the whole image or region of interest. This factor ensures that the overall image content must change by a certain amount in order for a motion detection alarm to be generated. Its effect is to require motion of an object of some minimum size within the image. The factor is applied by requiring some number of pixels, such as 5%, to change before a motion detection alarm is generated. A maximal sensitivity factor is also applied to ensure that the overall change in image content does not exceed a predetermined value, such as 99%. In the case of a sudden change that does not constitute an alarm condition, such as turning on or off the ambient lighting, applying the maximal sensitivity factor will thus eliminate false alarms.

The second threshold factor, the pixel value threshold, is applied at the pixel level. This factor requires that the change in the pixel values for each of the colour channels from one image to the next must be greater than some threshold amount. If the change is less than some threshold then this indicates the change is due to random statistical fluctuation, or a minor change in lighting conditions.

Certain environmental factors, such as the refraction of sunlight on glass, can lead to false motion detection. To account for this phenomenon, a smoothing algorithm is preferably incorporated into the image analyzer. Rather than simply subtracting the pixel values of the last image from the current image, the analyzer uses the pixel values from the last N frames (where N is preferably 5). The range in pixel values creates a dynamic threshold which may be larger than the set pixel value threshold. If a pixel value is fluctuating, then changes within that range will not be considered to amount to a change in the pixel value for motion detection purposes.

There are thus four features implemented to minimize the incidence of false alarms. The analyzer divides the image into smaller regions of interest. A sensitivity factor is used to ensure that the change in the overall image content, the net image difference magnitude, is greater than some threshold value. In addition to an imager-wide threshold value, each pixel value must vary by more than a threshold amount in order for a difference to be recorded for that pixel location. Finally, a history of the past N frames is kept. This permits the use of a moving average of past pixel values, avoiding short-term random fluctuations from triggering a false alarm.

In a preferred embodiment, additional features may be activated to increase the processing speed associated with the image analyzer, although at the cost of accuracy. The image analyzer may be set to only execute its routine on every Nth frame, rather than on every frame received from the video camera 60. The image analyzer may also be set to only operate on select pixels within the region of interest, such as every Nth pixel, instead of on all pixels in the region.

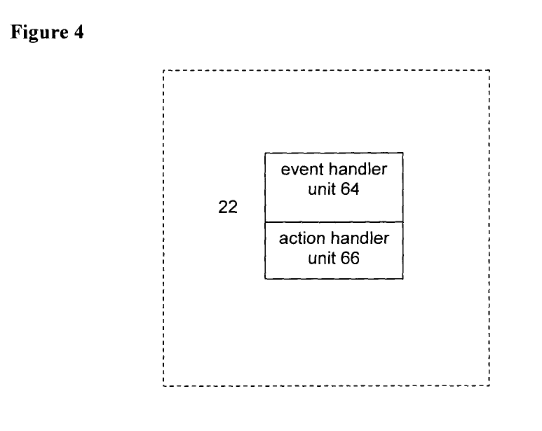

Turning to FIG. 4, the event generation module 22 comprises an event handler unit 64 and an action handler unit 66. Events are either triggered events or scheduled events. Triggered events arise upon the activation of a predetermined, but unpredictable trigger or alarm such as a motion detection identified by the video rendering unit 44. Scheduled events are predetermined and predictable, since their occurrence is defined by the user in the event generation module 22. A scheduled every may include a preset date and time. All events are recorded by the event generation module 22 with an inherent time component.

Actions are occurrences that are caused by events, and can include operations carried out by the video management unit 45, such as saving a video feed to a file, or operations carried out by the remote communications module 26, such as dispatching an electronic mail message or dialing a pager.

The event generation module 22 and the video management unit 45 thus provide automatic control over video recording and analysis. The video interpretation module 24, through its motion detection unit 47, can generate an alarm event in response to a change in the local surveillance area 10. Upon the detection of this alarm event by the event handler unit 64, the event generation module 22 directs the action handler 66 to take some action; for example, to send an electronic mail message to the remote computer 120 in order to advise a remote user of a possible break and enter in the local surveillance area 10. The remote computer 120 may be a central service, such as a security company, which monitors several local surveillance areas 10; most preferably, the remote communication module 26 is a duplex system which allows the user at the remote computer 120 to not only view the intruder at the local surveillance area 10 via the streaming near real time video provided by the rendering unit 44, but is also provided with a speaker system in the local surveillance area 10 (not shown) to allow the remote user to speak to the intruder.

The event generation module 22 through the action handler 66, upon detection of an alarm event, may further instruct the video management unit 45 to commence recording of the video feed for future references, and also most preferably operate certain automated devices in the local surveillance area using an automation protocol such as the X-10 protocol. The host computer 20 would therefore also be connected to a device controller, such as a CM17a X-10 controller (not shown), which when activated transmits an RF signal to a receiver connected to an electrical circuit in the local surveillance area 10 in order to activate an appliance, such as turn on a light fixture. Thus, the event generation module 22 can act as a trigger for video capture; a support mechanism to aid video capture, by turning on lighting; or as a response mechanism to take action as a result of the analysis of a video capture event.

In operation, the security system is provided with a software management system with a graphical user interface to provide control and direction of the security system to the user. The system combines several diverse capabilities to provide a fully functional and useful security system within a single piece of software.

The system incorporates an interface for connecting a digital camera to a computer. Through this interface a user is able to monitor the camera, record images or a video stream directly to the hard disk and later playback those files. For ease of installation, the security system preferably employs plug-and-play technology to allow an unsophisticated user to install the system with a minimum of difficulty. A user first connects the video camera 60 to a personal computer operating as the host computer 20, through a USB port for example. The software will recognize the camera 60 and enable the user to view the video feed from the camera 60. The user may then adjust the camera 60 viewing angle to include areas of interest for monitoring, such as a cash register or an entry door.

Once the camera 60 is installed on-site and connected to the host computer 20, the event scheduling module portion 22 of the software provides the user with the option to set a variety of tasks to be automated. The scheduling module 22 directs all automated operation of the security system. The user may define a trigger event such as a motion detection alarms for specific starting and ending times, for specified days of the week (individual days, or weekends and weekday evenings, for example). For each motion detection alarm, at least one action is defined; for example, one or more of the actions of sending an e-mail notification to a designated address; dialing a phone number associated with a telephone, pager, or personal digital assistant; capturing and recording the detected motion on video; operating appliances, or turning on/off light fixtures in the local surveillance area may be associated with the alarm.

Preferably, the an e-mail action is defined to include the attachment of a frame of the captured video, or even a video clip, to the e-mail message. If a video clip is attached to the e-mail message, then the host computer must be configured to record video mages for a set period of time following the motion detection alarm, but before the e-mail message is sent.

The system may also activate automated devices or circuits upon the triggering of a motion detection alarm. Preferably, devices are controlled by an automation protocol such as the X-10 protocol.

By way of example, the event scheduling module 22 may be set to respond to a motion detection at an entry door between 5 pm and 8 am on weekdays. Any motion detected in that window would trigger an alarm event in the scheduling module 22, causing the module 22 to direct the video module 24 to record video until the motion has ceased (or for a predetermined time, such as a half hour period). The events is preferably indexed into the recorded video file, if the file format supports such indexing, or is indexed in a database maintained by the video management unit 45. The user could also instruct the event scheduling module 22 to send an alert, via e-mail, pager, phone or video e-mail if the motion detection event occurred after 10 pm and before 6 am. The scheduler 22 would then also initiate an action in the form of an alarm via the user's choice of remote communication 130. Thus, a log would be generated for normal after-hours entry and an alarm raised for entries outside of normal hours.

The user may connect remotely to the host computer 20 to view the video feed, or adjust scheduling parameters in the event scheduler 22. Preferably this would require setting up a username and password within the remote communication module 26 of the host computer 20. If the host computer 20 is connected to the Internet, the user can install the software on a remote computer 120 also connected to the Internet and access the host computer 120 over that network. After logging on to the host computer 20, the user has full functional access over all software controls. The user may thus access the scheduling module 22 to edit previously scheduled events or add new events to the module 22, or edit or add trigger events and their corresponding actions. For example, the user may change an alarm notification action from a pager to an e-mail. Furthermore, through the remote communication module 26, the user may have remote access to both near real time streaming video and stored archival video files on the host computer 20. Since indexing is stored in the video file, the remote computer 120 will also provide access to the logs generated by the scheduling module 22 and the database management of the video files in the video management unit 45.

The surveillance system may further perform scheduled events. These events may include the actions described above in the context of the motion detection alarm, such as sending an e-mail to a predetermined recipient or turning on or off light fixtures. The events may also include activating or deactivating other X-10 controlled devices.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A system for operating a digital video security system comprising:
a video module for rendering video images captured by a video camera, and
an event scheduling module for generating signals in response to at least one predefined event,
wherein the video module renders said video images in response to a signal generated by the event scheduling module.

2. The system of claim 1, wherein said predefined event includes a triggering event or a scheduling event.

3. The system of claim 2, wherein said predefined triggering event includes motion detection or the activation or deactivation of an appliance.

4. The system of claim 3, wherein said scheduled event includes a preset time for commencing a video recording.

5. The system of claim 4, wherein said video module includes means for recording the video images in a video file.

6. The system of claim 5, wherein said video file comprises a time-indexed representation of said video images.

7. The system of claim 6, wherein the video module comprises database means containing at least one external time index corresponding to at least one portion of said video file, the external time index further corresponding to the at least one predefined event.

8. The system of claim 7 further comprising a communications module for transmitting said video images to a remote computer using streaming technology.

9. The system of claim 1 further comprising a communications module for communicating with a remote computer.

10. The system of claim 9 wherein the remote computer is provided with a video module for rendering video images captured by a video camera, an event scheduling module for generating signals in response to at least one predefined event, and a communications module for communicating with another computer, wherein the remote computer is operable to control the security system.

11. The system of claim 8 wherein the video module further comprises means for motion detection.

12. A system for managing a digital video file associated with a security system, the digital video file comprising time-indexed footage recorded by a video camera, comprising:
a database comprising at least one external time index associated with a predefined event,
means for presenting a list of the predefined events to a user,
means for the user to select one of the list of predefined events,
means for replaying a portion of the video file, the portion of the video file comprising time-indexed footage corresponding to the external time index associated with the predefined event selected by the user from the list of predefined events.

13. The system of claim 10 wherein the video file is replayed at a location remote from the video camera.

14. The system of claim 11 wherein the means for the user to select one of the list of predefined events is at a location remote from the video camera.

15. The system of claim 12 further comprising means for extracting a still image from said time-indexed footage corresponding to the external time index associated with the predefined event.

16. The system of claim 13 wherein the predefined event is a motion detected by the said video camera.

17. A method of detecting motion using a digital video camera comprising the steps of:
(a) receiving a first frame comprising an array of pixels from the video camera;
(b) receiving a second frame comprising an array of pixels from the video camera;
(c) comparing the colour values in each pixel on the second frame against the colour values in the corresponding pixel in the first frame, and if the differences between said first and second frames for all colour values associated with a pixel are greater than a first tolerance value, registering a change in association with that pixel;
(d) comparing the total number of pixels in the second frame for which a change is registered against a second tolerance value, and if said total number exceeds said second tolerance value, registering a motion detection.

18. A method of detecting motion using a digital video camera comprising the steps of:
(a) calculating average colour differential values for each of an array of pixels from a series of frames previously received from the video camera;
(b) receiving a first frame comprising an array of pixels from the video camera;
(c) receiving a second frame comprising an array of pixels from the video camera;
(d) comparing the colour values in each pixel on the second frame against the colour values in the corresponding pixel in the first frame, and if the differences between said first and second frames for all colour values associated with a pixel are greater than a first tolerance value and greater than the corresponding average colour differential value, registering a change in association with that pixel;
(e) comparing the total number of pixels in the current frame for which a change is registered against a second tolerance value, and if said total number exceeds said second tolerance value, registering a motion detection.

19. A security system comprising:
a digital video camera,
a host computer operably connected to the camera to receive video images from the camera, and
at least one remote computer in communication with the host computer over a network,
wherein the host computer streams video images to the remote computer in Microsoft Windows Media format.

20. A security system comprising:
a digital video camera,
a host computer operably connected to the camera to receive video images from the camera, and
at least one remote computer in communication with the host computer over a network,
wherein the host computer delivers the video images to the remote computer in a streamed video format.

21. The security system of claim 17 wherein the streamed video format is a Microsoft Windows Media system format.

22. The security system of claim 17 wherein the host computer receives video images from the camera in response to a signal generated in response to a predefined event.

23. The security system of claim 19 wherein the predefined event is associated with an event time index and the video images are associated with a series of time indices, and the system further comprises means for identifying a video image with an associated time index matching an event time index.

24. The security system of claim 17 wherein the video images are optionally delivered in near real time to the remote computer or at a time later than the time at which the video images are received by the host computer.

25. The security system of claim 20 wherein the event time index is the time associated with a motion detection.

26. The security system of claim 22 wherein the motion detection is detected by the digital video camera.

27. A method for maintaining surveillance of a surveillance area, comprising the steps of:
(a) providing a host computer with a security system comprising a video module for rendering video images captured by a video camera, an event scheduling module for generating signals in response to at least one predefined event, wherein the video module renders said video images in response to a signal generated by the event scheduling module, and a remote connection module for communicating with another computer over a network;
(b) providing a remote computer connected to the host computer over a network, the remote computer being provided with a security system comprising a video module for rendering video images captured by a video camera and retrieving images captured by a video camera, an event scheduling module for generating signals in response to at least one predefined event, and a remote connection module for communicating with the host computer over the network;
wherein signals generated by the event scheduling module on the remote computer are receivable by the host computer such that the video module on the host computer renders said video images.
